(19) United States
(12) Patent Application Publication
(10) Pub. No.: US 2012/0304970 A1
(43) Pub. Date: Dec. 6, 2012

(54) Mixing Pipe for Recirculated Exhaust Gas and Air

(75) Inventor: Udo Schlemmer-Kelling, Molfsee (DE)

(73) Assignee: Caterpillar Motoren GmbH & Co. KG, Kiel (DE)

(21) Appl. No.: 13/514,529

(22) PCT Filed: Jun. 22, 2010
(86) PCT No.: PCT/EP10/03806

§ 371 Date: Aug. 21, 2012

(30) Foreign Application Priority Data
Dec. 9, 2009 (EP) 09015247.1

(51) Int. Cl. F02M 25/07; B23P 6/00; F02B 47/10

(52) U.S. Cl. 123/568.12; 123/568.14; 29/402.08

(57) ABSTRACT

The present disclosure refers to a mixing pipe for mixing recirculated exhaust gas and air, preferably supplied by a high pressure compressor, and supplying a mixture of the exhaust gas and the air to a plurality of combustion chambers of an internal combustion engine. The mixing pipe may comprise a first mixing pipe section having a mixing pipe inlet and a mixing pipe outlet. The distance between the mixing pipe inlet and the mixing pipe outlet may have a predetermined length, wherein the predetermined length of the first mixing pipe section is configured to achieve a defined mixing ratio of the exhaust gas and the air at the mixing pipe outlet.

### TECHNICAL FIELD

The present disclosure generally refers to a mixing pipe for mixing recirculated exhaust gas and air and supplying the mixture of the exhaust gas and the air to a plurality of combustion chambers of the internal combustion engine, e.g., a large internal combustion engine configured to burn heavy fuel oil. The present disclosure also refers to a mixing pipe segment configured to be connected to another mixing pipe segment for forming a mixing pipe of the type mentioned herein. In addition, the present disclosure refers to a method for mixing recirculated gas and air and supplying a mixture of the exhaust gas and the air to a plurality of combustion chambers of an internal combustion engine. Finally, the present disclosure refers to a method for repairing a mixing pipe consisting of a plurality of mixing pipe segments.

### BACKGROUND

Exhaust gas recirculation systems (also referred to as EGR systems) are employed by internal combustion engines to help reduce various engine emissions. A typical EGR system may include a conduit, or other structure, fluidly connecting some portion of the exhaust path of an engine with some portion of the air intake system of the engine to thereby form an EGR path. Different amounts of exhaust gas recirculation may be desirable under different engine operating conditions. In order to regulate the amount of exhaust gas recirculation, such systems typically employ an EGR valve that is disposed at some point in the EGR path.

Systems have been developed to control EGR flow by regulating the amount of exhaust gases that are recirculated under various operating conditions, e.g., by controlling the position of an EGR valve. Some systems include an actuator for opening and closing the EGR valve, wherein the actuator is controlled by software-implemented control logic. Depending on the operating conditions of the engine, the control logic may position the EGR valve to allow varying amounts of exhaust gases to be recirculated.

While larger amounts of exhaust gas recirculation (i.e., higher EGR flow rates) may, under certain engine operating conditions, reduce emissions, various components may be affected by the EGR flow rate and, as such, may be taxed beyond their operating limits if EGR flow rates get too high. Exemplary components and/or engine operating parameters that can be affected by EGR flow rate may include turbo chargers, engine temperature, exhaust temperature, exhaust pressure, catalytic converters, particulate traps, air-to-air after coolers (ATAAC), EGR coolers, etc. In addition, condensation of gases in the air intake track of the engine may also become problematic at higher EGR flow rates.

EGR systems have been developed that are configured to improve the efficiency of EGR systems, see e.g., U.S. Pat. No. 7,389,770 B2, AT 504 179 B1, DE 100 54 604 A1, U.S. Pat. No. 5,957,116 A, U.S. Pat. No. 6,523,529 B1, U.S. Pat. No. 7,278,412 B2, DE 100 54 604 A1, DE 10 2005 052 708 A1, and DE 11 2007 002 869 T5.

In particular, EGR systems have been developed that are configured to improve the level of mixture of recirculated exhaust gas and air. The air may be supplied by a compressor, e.g. a high pressure compressor.

For example, DE 10 2005 019 776 A1, discloses an exhaust gas recirculation device configured to recirculate an exhaust gas from an exhaust gas duct to a suction duct. A recirculated exhaust gas discharging area is arranged in a mixing pipe in the flow direction of fresh air, before an air manifold. The pipe has a curvature ranging between 215° and 340° before an inlet in the air manifold, with respect to an axis that is arranged parallel to a longitudinal axis of the engine. Such an arrangement shall improve the mixing ratio of the exhaust gas and the fresh air so that the mixture of the recirculated exhaust gas and the fresh air and its mixing ratio is for all cylinders of the internal combustion engine the same before the mixture enters the various combustion chambers of the internal combustion engine. The disclosed exhaust gas recirculation device is disclosed for internal combustion engines configured to be used in motor vehicles and the exhaust gas recirculating device may need a considerable space which may not be available, in particular at large internal combustion engines configured to burn heavy fuel oils.

The present disclosure is directed, at least in part, to improving or overcoming one or more aspects of prior systems.

### SUMMARY OF THE DISCLOSURE

In a first exemplary aspect of the present disclosure a mixing pipe is provided. The mixing pipe is configured to mix recirculated exhaust gas and air and supplying the mixture to a plurality of combustion chambers of an internal combustion engine. The mixing pipe may comprise a first mixing pipe section having a mixing pipe inlet and a mixing pipe outlet. The distance between the mixing pipe inlet and the mixing pipe outlet may have a predetermined length. The predetermined length of the first mixing pipe section may be configured to achieve a defined mixing ratio of the exhaust gas and the air at the mixing pipe outlet. The mixing pipe further may comprise a second mixing pipe section coupled to the mixing pipe outlet of the first mixing pipe section. The second mixing pipe section may be provided with a plurality of outlets, each outlet may be configured to be coupled to a duct supplying a portion of the gas mixture to an associated combustion chamber of the plurality of combustion chambers. In addition, the first mixing pipe section and the second mixing pipe section may extend substantially parallel to each other. The defined mixing ratio of the mixture of the recirculated exhaust gas and the air may be set such that it may not substantially vary after entering in the second mixing pipe section, and, consequently, the mixing ratio may be substantially the same before the mixture enters into the various combustion chambers.

Accordingly, in a mixing pipe according to the present disclosure, the mixing of the recirculated exhaust gas and the fresh air may mainly be effected in the first mixing pipe section and, therefore, the mixing ratio of the mixture of the recirculated exhaust gas and the air may not substantially vary after entering in the second mixing pipe section, and, consequently, the mixing ratio may be substantially the same before the mixture enters into the various combustion chambers. Simultaneously, the occupied space may be minimized.

In another exemplary aspect of the present disclosure a mixing pipe segment for forming a mixing pipe may be configured to be connected to another mixing pipe segment. Accordingly, a plurality of mixing pipe segments may form a mixing pipe of the type disclosed herein, and an easy and simple replacement of, e.g. defective, mixing pipe segments may be possible.

In another exemplary aspect of the present disclosure a method is provided, which method may be used for mixing recirculated exhaust gas and air and supplying the mixture of the exhaust gas and the air to a plurality of combustion chambers of an internal combustion engine. The method may comprise at least one of the method steps of supplying recirculated exhaust gas at a predetermined position into a flow of air, guiding the supplied exhaust gas and the air along a predetermined first direction over a predetermined length starting from that predetermined position so that a gas mixture of the exhaust gas and the air has a defined mixing ratio at the end of the predetermined length, diverting the sufficiently mixed gas mixture of the exhaust gas and the air in a second direction substantially opposite and extending substantially parallel to the first direction, and distributing the gas mixture to the plurality of combustion chambers at a plurality of different positions. According to an exemplary embodiment of a mixing pipe disclosed herein, the gas mixture may be distributed to the combustion chambers along a direction substantially perpendicular to the direction in which the second mixing pipe section may extend.

In another aspect of the present disclosure a method is provided, which method may be used for repairing a mixing pipe consisting of a plurality of separate mixing pipe segments. The method may comprise disconnecting a mixing pipe segment of the plurality of mixing pipe segments which form the mixing pipe, and replacing the disconnected mixing pipe segment by a new (or renewed) mixing pipe segment.

Other features and aspects of this disclosure will be apparent from the following description and the accompanying drawings.

### BRIEF DESCRIPTION OF THE DRAWINGS

FIG. 1 shows a schematic diagram of an internal combustion engine comprising a mixing pipe according to a first exemplary embodiment of the present disclosure;

FIG. 2a shows a section of the mixing pipe shown in FIG. 1 at line

FIG. 2b shows a schematic section of a mixing pipe similar to the mixing pipe shown in FIG. 2a, the mixing pipe shown in FIG. 2b having a different cross sectional shape;

FIG. 3 shows a schematic section of a internal combustion engine provided with an exemplary embodiment of a mixing pipe according to the present disclosure;

FIG. 4 shows a longitudinal sectional view of the mixing pipe as provided in the internal combustion engine of FIG. 3;

FIG. 5 shows a cross sectional view along line V-V of FIGS. 4; and

FIG. 6 shows a portion of a mixing pipe according to another exemplary embodiment, which may comprise a plurality mixing pipe segments connected via at least one connecting piece.

### DETAILED DESCRIPTION

Generally, the used terminology “substantially parallel” used herein may mean that a longitudinal axis of the first mixing pipe section and a longitudinal axis of the second mixing pipe section extend exactly parallel to each other, are identical, or may have an included angle of less than 20°.

Furthermore, the used terminology “substantially perpendicular” used herein may mean that a longitudinal axis of the second mixing pipe section and a flowing path of the gas mixture into ducts guiding the gas mixture to combustion chambers may have an included angle in a range of 70°-120°.

In addition the terminology “large internal combustion engine” used herein may refer to internal combustion engines which may be used as main or auxiliary engines of ships/vessels such as cruiser liners, cargo ships, container ships, and tankers, or in power plants for production of heat and/or electricity, or the like. In particular, large internal combustion engines may be configured to burn at least one fuel selected from the group consisting of diesel and heavy fuel oil (HFO).

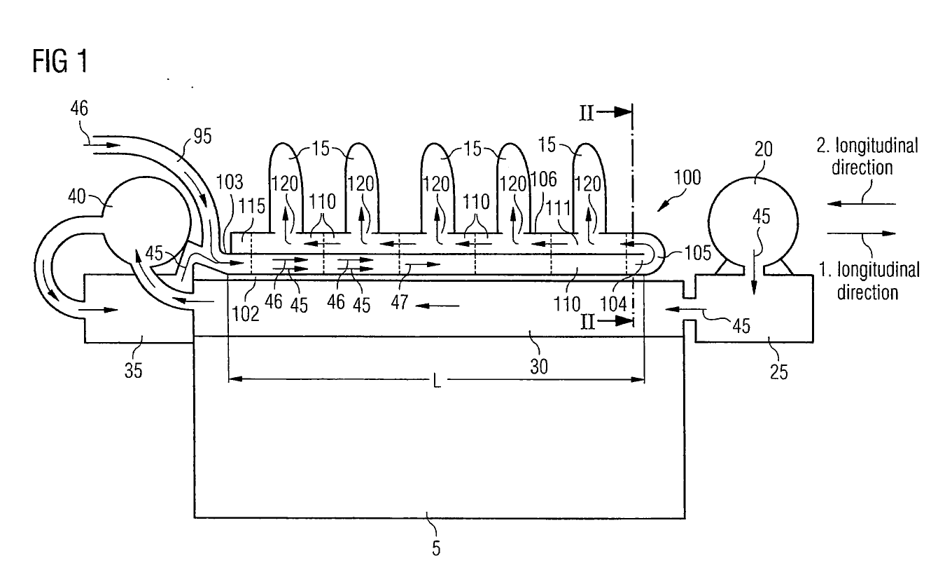

Referring to FIG. 1, an internal combustion engine 5 extending along a longitudinal direction is shown, for example a large internal combustion engine configured to burn inter alia heavy fuel oil or their like is shown. On a front side of the internal combustion engine 5 a low pressure compressor 20 may be located, low pressure compressor 20 may being connected to an intake air cooler 25. Intake air cooler 25 in turn is connected to an inlet of a duct 30 extending from the front end to another opposite front end of internal combustion engine 5.

At the opposite front end of internal combustion engine 5 a high pressure compressor 40 may be arranged. High pressure compressor 40 may be connected to an outlet of duct 30 located at the opposite front end of internal combustion engine 5. High pressure compressor 40 may also be connected to a further cooler 35 in which compressed intake air supplied by compressor 40 may be cooled.

Cooler 35 may be connected to a mixing pipe 100. Mixing pipe 100 may be located at an upper side of internal combustion engine 5, e.g. adjacent to duct 30. Alternative locations for mixing pipe 100 are possible, e.g. between cylinders of V-type internal combustion engine. Mixing pipe 100 may comprise a first mixing pipe section 102 and a second mixing pipe section 106. First mixing pipe section 102 may include a mixing pipe inlet 103 and a mixing pipe outlet 104. Mixing pipe inlet 103 may be connected to an outlet 36 of cooler 35. A pipe 95 may also be connected to mixing pipe inlet 103. The pipe 95 may be connected to an exhaust gas recirculation system for recirculating exhaust gas 46 from an exhaust side of internal combustion engine 5.

The distance between mixing pipe inlet 103 and mixing pipe outlet 104 may have a predetermined length L so that the exhaust gas 46 and the air 45 leaving cooler 35 mix with each other so that a defined mixing ratio may be achieved at the area of mixing pipe outlet 104. First mixing pipe section 102 may extend at least over half or about the whole length of the internal combustion engine 5 or its engine block.

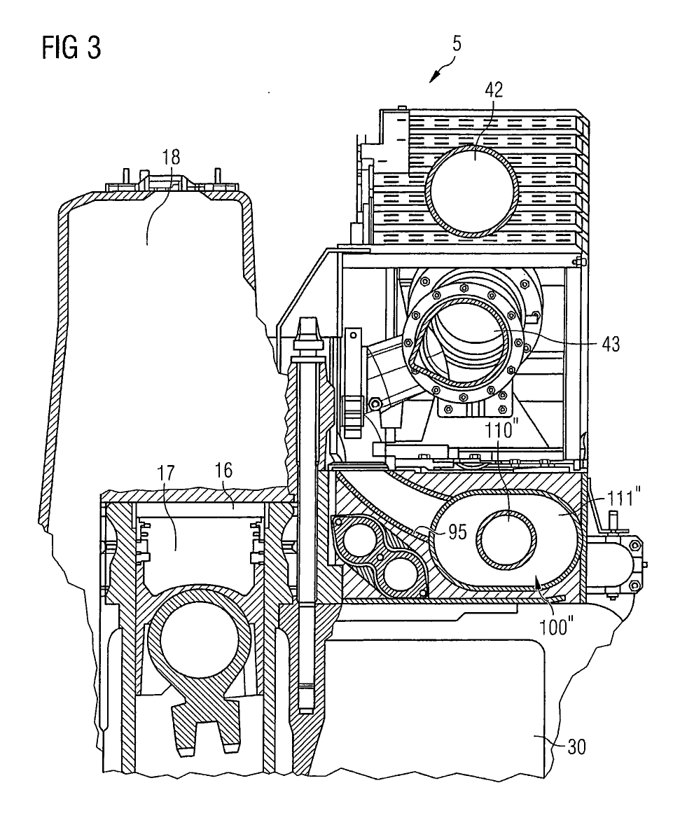

Second mixing pipe section 106 may be coupled to mixing pipe outlet 104 via a coupling segment 105 and may be provided with a plurality of outlet 120. Each outlet 120 may be configured to be coupled to a duct 15 of a plurality of ducts 15. Each duct 15 may be connected to a combustion chamber 16 (see e.g. FIG. 3) of a plurality of combustion chambers 16 of internal combustion engine 5. Second mixing pipe section 106 may include a closed end part on the front end opposite to coupling segment 105.

Coupling segment 105 may be configured to turn or divert the mixture of exhaust gas 46 and intake air 45 discharged at mixing pipe outlet 104 by an angle ranging between about 160° to 200°, in particular about 180°, to an inlet of second mixing pipe section 106. In other words: a longitudinal direction of the first mixing pipe section 102 and a longitudinal direction of second mixing pipe section 106 may insert an angle of about 0° to 40°.

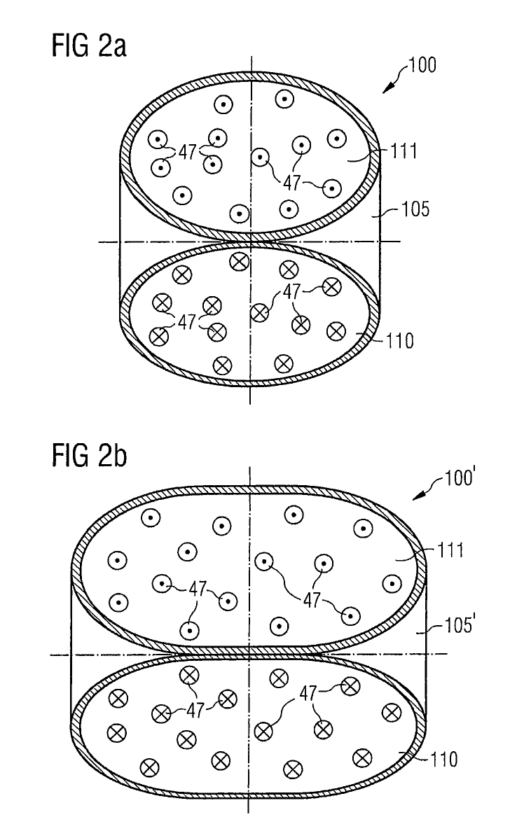

FIG. 2a shows a schematic cross sectional view of mixing pipe 100 along line II-II of FIG. 1. Mixing pipe 100 may comprise first mixing pipe section 102 and second mixing pipe section 106. Both may have identical, similar, or different cross sectional shapes. In the exemplary embodiment of mixing pipe 100 shown in FIG. 2a first mixing pipe section 102 and second mixing pipe section 106 have identical cross sectional shapes and may be arranged adjacent to each other. Second mixing pipe section 106 may be located above first mixing pipe section 102. However, in other exemplary embodiments of mixing pipe 100 first mixing pipe section 102 and second mixing pipe section 106 may be arranged side by side, or in any another configuration.

Referring to FIG. 2b another exemplary embodiment of mixing pipe 100′ is shown. Contrary to the exemplary embodiment of mixing pipe 100 shown in FIG. 2a mixing pipe 100′ shown in FIG. 2b may have another cross sectional shape. In particular, first mixing pipe section 102 may have a cross sectional shape other then circular, e.g. elliptic, oval, block shaped etc. The second mixing pipe section 106 may also have a cross sectional shape which is not circular, for example elliptic, oval, block shaped etc.

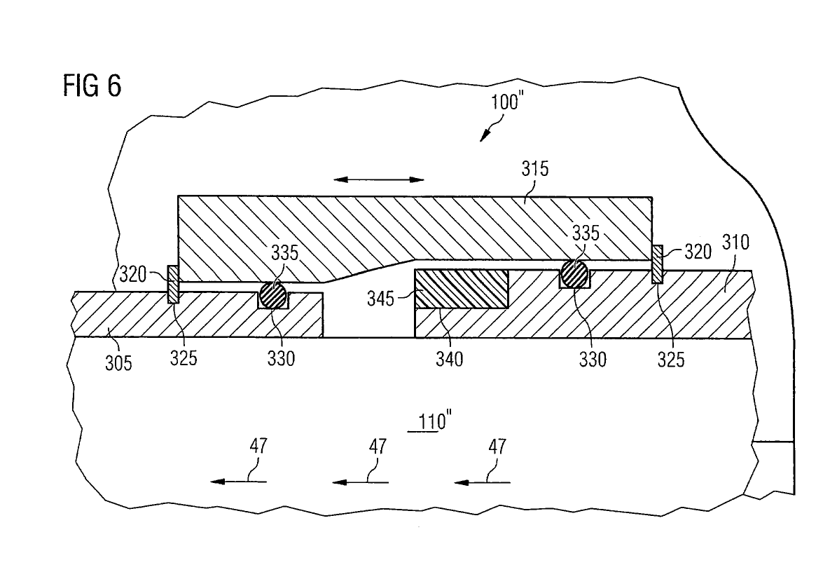

Both embodiment of mixing pipe 100, 100′ shown in FIGS. 2a and 2b may be formed in one piece, but it is also possible, to provide each mixing pipe segment 102 and 106 separate and connect them by welding, bolting, clamping etc. This may also apply to the further exemplary embodiments of mixing pipes shown in the other Figs. It may also appropriate to provide a plurality of mixing pipe segments each comprising a portion of first mixing pipe section 102 and second mixing pipe section 106. For example, a mixing pipe segment may have a predetermined length so that one mixing pipe segment may be associated to one (ore more) duct(s) and combustion chamber(s). Alternatively, a mixing pipe segment may comprise only a portion of first mixing pipe section 102 and second mixing pipe section 106. For more details see FIG. 6 and the accompanying description.

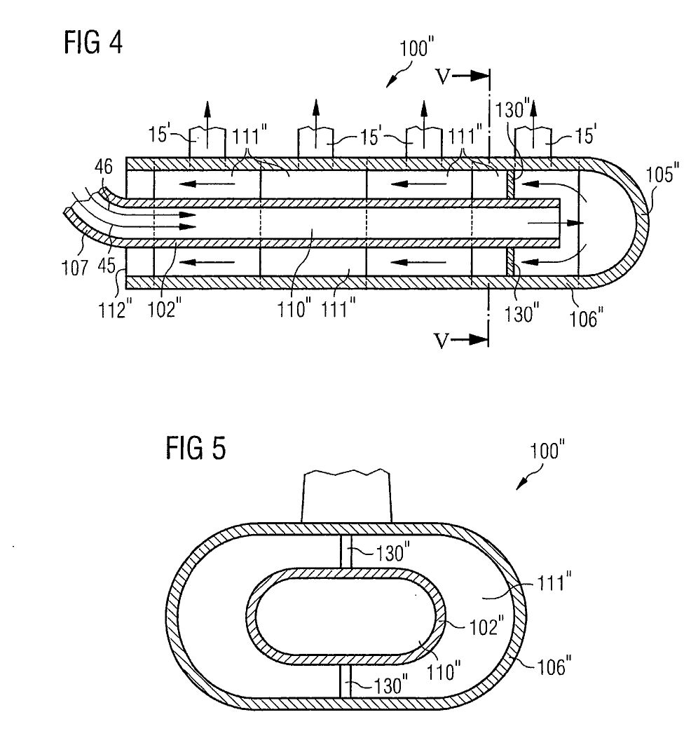

FIG. 3 shows a schematic sectional view of an internal combustion engine 5 which may comprise a plurality of cylinders 18. Each cylinder 18 may comprise one of the plurality of combustion chambers 16. Each combustion chamber 16 may be defined by a piston 17. On the side of cylinders 18 mixing pipe 100″ may be located. Mixing pipe 100″ may have another configuration as mixing pipes 100 shown in FIGS. 1-2b. Further details of mixing pipe 100″ are shown in FIGS. 4 and 5.

Above mixing pipe 100″ a high pressure exhaust gas duct 43 may be located. High pressure exhaust gas duct 43 may be connected to duct 95 shown in FIG. 1.

A low pressure exhaust gas duct 42 may be arranged above high pressure exhaust gas duct 43. Low pressure exhaust gas duct 42 may be connected to a turbine (not shown) configured to pressurize the low pressure exhaust gas. Duct 30 for the low pressure exhaust gas (see FIG. 1) may be located below mixing pipe 100″.

FIGS. 4 and 5 show another exemplary embodiment of a mixing pipe 100″ as already schematically shown in FIG. 3. This exemplary embodiment of mixing pipe 100″ may comprise a first mixing pipe section 102″ and a second mixing pipe section 106″. First mixing pipe section 102″ may be housed within the interior 111″ of second mixing pipe section 106″. First mixing pipe section 102″ may be connected to an inlet portion 107 which in turn may be connected to duct 95 and cooler 35. Second mixing pipe section 106″ may comprise a closed end part 105″ and another closed end part 112″ opposite closed end part 105″. Closed end part 112″ may be penetrated by inlet part 107. First mixing pipe section 102″ may be mounted within the interior 111″ of second mixing pipe section 106″ via the end of end part 112″ and struts 130″.

First mixing pipe section 102″ may be located within second mixing pipe section 106″ so that mixture of the exhaust gas 46 and the intake air 45 discharged at the outlet of first mixing pipe section 102 may flow around at least part of the outer surface of first mixing pipe section 102″. As indicated in FIG. 4, ducts 15 may be connected to outlets 15 of second mixing pipe section 106″.

FIG. 5 shows a schematical cross section view along line V-V of FIG. 4. Two struts 130″ mount the open end of first mixing pipe section 102″ within the interior 111″ of second mixing pipe section 162′. In other exemplary embodiments different struts or another number of struts may be provided for mounting the first mixing pipe section 102″ within second mixing pipe section 106″.

Referring to FIG. 6 another exemplary embodiment of a mixing pipe 100″ is shown. Here, mixing pipe 100″ may comprise a first mixing pipe segment 305 and a second mixing pipe segment 310. Adjacent first and second mixing pipe segments 305, 310 may be coupled via a connector segment 315.

Connecting segments 315 may be fixed in longitudinal direction of mixing pipe 100″ via, for example, a locking ring 320. Other mechanical locking means may be contemplated, for example screws, bolds etc. Locking rings 320 may be placed within a groove 325 formed at the outer surface of segments 305, 310. Each segment 305, 310 may be provided with a further groove 330 in which a seal ring, for example a O-ring, is inserted. Sealing rings 335 may contact an inner surface of connecting segments 315 for providing a fuel between the two segments 305, 310 so that no gas of the gas mixture flowing within interior 110″ may leak from the interior 110″.

If the temperature of the gas mixture of exhaust gas and air flowing within interior 110″ may fall below dew point sulfur acid may be generated. Sulfur acid may be problematic with respect to corrosion of segments 305, 310 and other parts like a segment 315.

In the exemplary embodiment of a mixing pipe 100″ shown in

FIG. 6 mixing pipe segment 310 may be provided with a step 340 shaped for receiving a ring 345 which may contain or is made of alkaline earth oxides, e.g. selected from the group consisting of CaO, BaO, and MgO. The alkaline earth oxide of ring 345 may be configured to neutralize sulfur acid which may condensate in interior 110″, if the temperature falls below a specific temperature, e.g. the dew point of sulfur acid. As ring 345 may be able to absorb or bind sulfur acid, corrosion within mixing pipe 100″ may be reduced. As the absorption capacity of ring 345 may be limited, ring 345 may be fitted in a exchangeable manner on or at step 340.

Alternatively, ring 345 may be configured to line the inner surface of segments 305, 310, 315 at least in part. In another exemplary embodiment of a mixing pipe 100, 100″ the mineral may be sputtered or painted on at least portions of surfaces of segments 305, 310, 315 etc. Accordingly, corrosion of these parts may be reduced.

### INDUSTRIAL APPLICABILITY

Referring to FIGS. 1 and 2a, the basic principle of operation of the EGR system of internal combustion engine 5 is explained in the following.

Intake air may be supplied to low pressure compressor 20. In low pressure compressor 20 intake air may be pressurized and discharged to cooler 25. In cooler 25 the compressed intake air may be cooled to a defined temperature. Cooled and compressed intake air leaving cooler 25 may enter into duct 30 and may flow from one front end to another front end of internal combustion engine 5.

Intake air flow may enter into high pressure compressor 40. In high pressure compressor 40 the intake air may be further compressed up to a defined pressure level. The high pressure intake air discharged by high pressure compressor 40 may be supplied to cooler 35. In cooler 35 the high pressure intake air may be cooled down to a defined temperature. The high pressure intake air having a reduced defined temperature may be discharged into mixing pipe inlet 103.

Recirculated exhaust gas may also be supplied into mixing pipe inlet 103. Accordingly, the recirculated exhaust gas 46 and high pressure intake air having a reduced temperature may flow from mixing pipe inlet 103 to mixing pipe outlet 104 in interior 110 of mixing pipe 100 (or 100″). In interior 110 further mechanical means for increasing mixing of the two gas flows 45, 46 may be provided.

As the intake air 45 and exhaust gas 46 may flow along first mixing pipe section 102 over a distance L which may extend for at least half of the length of the engine 5 the two gas flows 45, 46 may sufficiently mix so that a defined mixing ratio of the two gas flows 45, 46 may be achieved at the end at mixing pipe outlet 104. The gas mixture having a defined mixing ratio may then deflected into second mixing pipe section 106 and flow in each duct 15 and further to the associated combustion chambers 16.

As a predefined mixing ratio may already be achieved at mixing pipe outlet 104 the mixing ratio may be roughly similar or identical in each duct 15. The space occupied by first mixing pipe section 102 and second mixing pipe section 106 may be reduced due to the specific arrangement of the two sections 102, 106 to each other.

According to the present disclosure mixing pipes 100, 100″ may take advantage of the longitudinal dimension of engine 5 for providing a sufficient mixture of the two gas flows 45, 46.

As indicated in FIG. 1, mixing pipe 100 may be assembled from a plurality of mixing pipe segments 110. The segments 110 may be connected with each other via a connecting segment as for example shown in FIG. 6. However, other ways for connecting two adjacent segments 110 are possible. For example, segments 110 may be welted, bolded, or connected via other mechanical means, e.g. positive locking engagement means.

In case of corrosion generated by sulfur acid contained within the gas mixture one or more segments 110 may have to be replaced after a defined time period. In this case, the connection between two adjacent segments may be released and a new segment 110 may be inserted.

In case of connecting means designed as a connecting means 315 of FIG. 6 locking rings 320 may be removed. Afterwards, ring 315 may be shifted in a longitudinal direction (to the left side in FIG. 6). Afterwards, segment 310 may be replaced by a new segment 310. In case that ring 345 has to be replaced only, ring 345 may be removed from step 340 and replaced by a new ring. Afterwards, connecting segment 315 may be shifted in the opposite direction and fixed by new rings 320. If necessary or appropriate, sealing rings 330 may be replaced, too.

Accordingly, a simple but efficient manner for replacing parts of mixing pipe 100, 100″ may be provided. In addition, corrosion of parts or portions of mixing pipe 100, 100″ may be reduced.

It will be apparent to those skilled in the art that various modifications and variations can be made to the disclosed mixing pipes and methods without departing from the scope of the present invention.

For example, in addition or supplementary to the exemplary embodiments disclosed above, according to an exemplary embodiment of a mixing pipe of the present disclosure the second mixing pipe section may have a length measured from a first outlet to a last outlet along a longitudinal direction of the second mixing pipe section and this length of the second mixing pipe section may being at least more than half of the predetermined length of the first mixing pipe section. The length of the first mixing pipe section may be at least half of the length of the engine or the engine block, e.g. the first mixing pipe section may have a length nearly identical with the length of the engine block.

According to another exemplary embodiment of a mixing pipe of the present disclosure the second mixing pipe section may have a first end and a second end. The first end may be open and the second end may be closed. The first mixing pipe section may be housed within the second mixing pipe section.

According to another exemplary embodiment of a mixing pipe of the present disclosure the mixing pipe may further comprise an exhaust gas inlet configured to induce the recirculated exhaust gases into the air at the pipe inlet.

According to another exemplary embodiment of a mixing pipe of the present disclosure the first mixing pipe section may be configured to be connected to an outlet of a high pressure compressor configured to discharge compressed air.

According to another exemplary embodiment of a mixing pipe of the present disclosure the mixing pipe may further comprise a cooling water passage arranged in parallel to at least of the first mixing pipe section and the second mixing pipe section.

According to another exemplary embodiment of a mixing pipe of the present disclosure the mixing pipe may be configured to be used in an internal combustion engine configured to burn heavy fuel oil.

According to another exemplary embodiment of a mixing pipe of the present disclosure the first mixing pipe section and/or the second mixing pipe section may consist of a plurality of separate mixing pipe segments configured to be connected to each other. The mixing pipe segments may be replaceable connected so that a plurality of mixing pipe segments may form a mixing pipe of the type disclosed herein.

According to another exemplary embodiment of the mixing pipe segment a separate connecting segment may be configured to connect two adjacent mixing pipe segments.

According to another exemplary embodiment of a mixing pipe consisting of a plurality of mixing pipe segments at least two mixing pipe segments may be identical constructed.

According to another exemplary embodiment of a mixing pipe the two passages formed within the mixing pipe may be arranged side by side or above each other.

1. A mixing pipe for mixing recirculated exhaust gas and air and supplying a mixture of the exhaust gas and the air to a plurality of combustion chambers of an internal combustion engine, the mixing pipe comprising:
a first mixing pipe section having a mixing pipe inlet and a mixing pipe outlet, the distance between the mixing pipe inlet and the mixing pipe outlet having a predetermined length, wherein the predetermined length of the first mixing pipe section is configured to achieve a defined mixing ratio of the exhaust gas and the air at the mixing pipe outlet;
a second mixing pipe section coupled to the mixing pipe outlet, the second mixing pipe section being provided with a plurality of outlets, each outlet being configured to be coupled to a duct supplying a portion of the gas mixture to an associated combustion chamber of the plurality of combustion chambers; and
wherein the first mixing pipe section and the second mixing pipe section extend substantially parallel to each other.

2. The mixing pipe of claim 1, wherein:
the second mixing pipe section has a length measured from a first outlet to a last outlet along a longitudinal direction of the second mixing pipe section; and
the length of the second mixing pipe section is at least more than half of the predetermined length of the first mixing pipe section.

3. The mixing pipe of claim 1, wherein:
the second mixing pipe section has a first end and a second end, the first end being open and the second end being closed; and
the first mixing pipe section is housed within the second mixing pipe section.

4. The mixing pipe of claim 1, further comprising:
an exhaust gas inlet configured to induce the recirculated exhaust gases into the air at the mixing pipe inlet.

5. The mixing pipe of claim 1, wherein the mixing pipe contains or is covered with a mineral to neutralize sulfur acid contained in the recirculated exhaust gas flow, in particular CaO, BaO, or MgO, at least at portions which may come into contact with the recirculated exhaust gas flow.

6. The mixing pipe of claim 1, wherein the first mixing pipe section is configured to be connected to an outlet of a high pressure compressor configured to discharge compressed air.

7. The mixing pipe of claim 1, further comprising:
a cooling water passage arranged in parallel to at least of the a first mixing pipe section and the second mixing pipe section.

8. The mixing pipe of claim 1, wherein the mixing pipe is configured to be used in an internal combustion engine configured to burn heavy fuel oil.

9. The mixing pipe of claim 1, wherein the first mixing pipe section and/or the second mixing pipe section are consisting of replaceable section segments configured to be connected to each other.

10. A mixing pipe segment configured to be connected to another mixing pipe segment so that a plurality of mixing pipe segments form a mixing pipe of any one of the preceding claims.

11. The mixing pipe segment of claim 10, wherein the mixing pipe segment includes a first front end and a second front end opposite the first front end, the first front end being configured to get into releasable engagement with a second front end of another mixing pipe segment.

12. The mixing pipe segment of claim 10, further comprising:
a separate connecting segment configured to connect two adjacent pipe section segments.

13. The mixing pipe segment of claim 10, wherein at least a portion or part of the mixing pipe segment contains or is covered with a material for neutralizing sulfur acid, in particular the material being CaO or BaO.

14. A method for mixing recirculated exhaust gas and air and supplying a mixture of exhaust gas and air to a plurality of combustion chambers of an internal combustion engine, the method comprising the steps of:
supplying recirculated exhaust gas at a predetermined position into a flow of air;
guiding the supplied exhaust gas and the air along a predetermined first direction over a predetermined length starting from that predetermined position so that a gas mixture of the exhaust gas and the air has a defined mixing ratio at the end of the length;
diverting the gas mixture of the exhaust gas and the air in a second direction substantially opposite and extending substantially parallel to the first direction; and
distributing the gas mixture to the plurality of combustion chambers at a plurality of different positions.

15. A method for repairing a mixing pipe of claim 10, the method comprising:
disconnecting a mixing pipe segment of the plurality of mixing pipe segments forming the mixing pipe; and
replacing the disconnected mixing pipe segment by a new mixing pipe segment.
